(19) United States
(12) Patent Application Publication
(10) Pub. No.: US 2001/0025252 A1
(43) Pub. Date: Sep. 27, 2001

(54) System and method for paying quiz prize money

(76) Inventor: Kohara Yoshimoto, Ureshinomachi (JP)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/725,114

(22) Filed: Nov. 29, 2000

(30) Foreign Application Priority Data
Mar. 24, 2000 (JP) 2000-083386

(51) Int. Cl. G06F 17/60; G09B 3/00

(52) U.S. Cl. 705/14; 434/332; 705/39

(57) ABSTRACT

The invention relates to providing of a quiz program utilizing the internet and, particularly, it allows the payment of a participation charge and the remittance of prize money to be carried out on a cashless basis and allows prize money to be allotted to payment for on line shopping and the like. Referring to the configuration, there is provided a system for connecting a terminal of a quiz participant and a terminal of a quiz runner through the internet and for providing prize money for right answers, formed by site selecting means for allowing the quiz participant to select a quiz site or a charged site as a site to be connected, quiz storing means for storing quizes to be given and right and wrong answers, quiz answering means for transmitting a quizzing screen to the terminal of the quiz participant to cause him or her to input answers, judging means for judging right and wrong answers to the quizes returned from the terminal of the quiz participant, and prize money calculating means for calculating the amount of prize money for right answers to the quizes. This makes it possible to give quizes, to judge right and wrong answers and to calculate the amount of prize money for right answers automatically using a computer.

### BACKGROUND OF THE INVENTION

1. Field of the Invention

The present invention relates to a quiz program provided on a free-of-charge basis or charged basis utilizing a home page or the like on the internet or the like, in which prize money is given to an answer for right answers and in which a computer automatically gives quizes, judges right and wrong answers and calculates the amount of acquired prize money. The invention is characterized by a system and a method for paying prize money acquired at a quiz program. Further, the invention makes it possible to allot prize money acquired at a quiz program to payment for on line shopping and other charged services.

Recently, home pages and the like on the internet and the like are used to provide various services and information. Some of them are run free of charge, and some are run on a charged basis. In any case, they will be less advantageous than expected because of low utilization unless their contents will be attractive enough for people having access to them. Under such circumstances, even for a home page which is primarily intended for on line shopping, there is a need for adding something which provides users with a different kind of entertainment in order to increase the access rate. In recent days when a great number of sites with similar contents are seen, it is especially important to increase the access rate of a site as a whole by providing it with unique contents which can not be seen in other sites. From such a point of view, for example, a site in which prize money can be won at games or quizes is expected to be advantageous.

2. Description of the Prior Art

Various patent applications have been made on games which are provided utilizing a communication network such as the internet and which can be used at remote locations.

For example, proposals relating to video game systems have been made including U.S. Pat. No. 4,652,998 and U.S. Pat. No. 5,324,035. However, they propose so-called home-use games which are provided on line and which are advanced versions of conventional computer games. Users enjoy the games themselves without any intention of winning prize money.

Various patent applications have been made also on games such as so-called bingo games having a chance factor as seen in gambles. For example, such proposals include Japanese unexamined patent publication No. H5-317485 and PCT international publication No. WO94/06526. In this case, however, a person can only participate a gate for earning money at a remote location instead of actively demonstrating his or her ability.

Proposals relating to lottery games include Japanese unexamined patent publication No. H7-255950 and PCT international publication No. WO97/02074. According to the proposals, however, a user is only enabled to buy a lottery the result of which is uncertain and to check whether he or she has won at a remote location.

Any of those games is played for the purpose of earning a great amount of money and is not intended for using prize money thus acquired for other purposes on the internet, e.g., allotting it to payment for on line shopping.

Thus, according to conventional proposals, a computer is used to generate a chance factor, and games are intended for the joy of such a chance factor in their nature. People participate those conventional games to enjoy the games themselves or simply to acquire a great amount of money. Therefore, although they are played through the internet, they are provided independently without any relationship with other services provided on the internet.

It is possible not only to store various types of information in a computer but also retrieve those pieces of information therefrom. By storing a great number of quizes in a computer and providing them through the internet by utilizing such properties of a computer, a right or wrong answer to a quiz can be obtained based on the ability of a person.

A lottery or bingo provides an uncertain result, and the purpose of participants is only to win prize money. The purpose of running such a game on the internet or the like is to free people from going to shops to by them.

On the contrary, a quiz is a challenge to the knowledge of a user, and a user has an advantage which is completely different from that in the case of a lottery or bingo. Specifically, the use of the internet allows a user to access a quiz any time at any place to enjoy the quiz at his or her convenience. What is intended is to satisfy intellectual curiosity of participants even if the prize money that can be acquired is small. The purpose is quite different from the purpose in the case of a lottery or bingo which is only to buy a ticket. While the purpose of a lottery or bingo is to simply acquire a great amount of money, quizes give a user a satisfaction with his or her own knowledge regarding how many right answers he or she can give.

Quizes will be more attractive for an internet user if he or she can win prize money for right answers, and it will be more convenient if the amount of prize money for right answers can be automatically calculated. Further, by making additions and changes to the contents of quizes stored in a computer from time to time, the rate of reutilization of users can be improved because new quizes can be always provided.

Further, by incorporating such a quiz program as one of sites of a home page for on line shopping or the like, the home page becomes more-convenient because it can accommodate shopping using acquired prize money instead of simply serving on line shopping. The utilization of a home page as a whole can be improved by providing a site in which prize money can be acquired with a high probability even though in a small amount.

A problem with such quizes utilizing the internet is how to collect participation charges for the quizes and how to remit the prize money. It would be convenient for both of the participants and the runner of a quiz program if the participation charges and prize money of quizes can be paid on a cashless basis because the quizes are given and answered utilizing the internet. When a runner of a quiz program also runs various charged sites such as on line shopping, it is more convenient if payments for shopping and the like can be settled using quiz prize money.

### SUMMARY OF THE INVENTION

Under such circumstances, a system for paying quiz prize money according to the invention is a system for connecting a terminal of a quiz participant and a terminal of quiz runner through the internet and for providing prize money for right answers, which has site selecting means for allowing the quiz participant to select a quiz site or a charged site as a site to be connected, quiz storing means for storing quizes to be given and right and wrong answers, quiz answering means for transmitting a quizzing screen to the terminal of the quiz participant to cause him or her to input answers, judging means for judging right and wrong answers to the quizes returned from the terminal of the quiz participant and prize money calculating means for calculating the amount of prize money for right answers to the quizes.

A method for paying quiz prize money according to the invention is a method for paying quiz prize money in which a quiz participant is connected to a screen of a quiz runner provided in a site of the internet to follow a procedure for participating a quiz program and for answering utilizing the screen and in which prize money acquired for right answers are paid based on a selection instruction from the quiz participant, the method having the steps of causing the quiz participant to select a quiz site or a charged site as a site to be connected, causing the quiz participant to select a method for payment of a quiz participation charge, transmitting a quizzing screen to the terminal of the quiz participant in response to the selection of the quiz participant and causing him or her to input answers, judgining right and wrong answers to quizes transmitted from the terminal of the quiz participant and calculating the amount of prize money for right answers to the quizes.

A quiz participant accesses a home page of a runner of a quiz program and selects a quiz site or a charged site on a site selection screen. When the quiz site is selected, a quizzing screen is transmitted to the terminal of the quiz participant, and the quiz participant inputs and returns answers. A computer judges whether the returned answers to quizes are right or wrong and notifies the quiz participant of the amount of prize money for right answers.

The quiz participant makes a selection on how to settle the prize money and, in accordance with the selection, the prize money is saved in a prize money storing apparatus at the quiz runner to use them as expense for participating a quiz program or expense for charged sites in which payment must be made for on line shopping and the like. Alternatively, the prize money is remitted to a bank account designated by the quiz participant.

### BRIEF DESCRIPTION OF THE DRAWINGS

FIG. 1 illustrates a system configuration of a system for paying quiz prize money according to the invention.

FIG. 2 is a flow chart showing a method for paying quiz prize money according to the invention.

FIG. 3 is a flow chart showing an example in which the method for settling prize money involves disposal of a prize.

FIG. 4 shows an example of a quizzing screen.

### DETAILED DESCRIPTION OF THE PREFERRED EMBODIMENTS

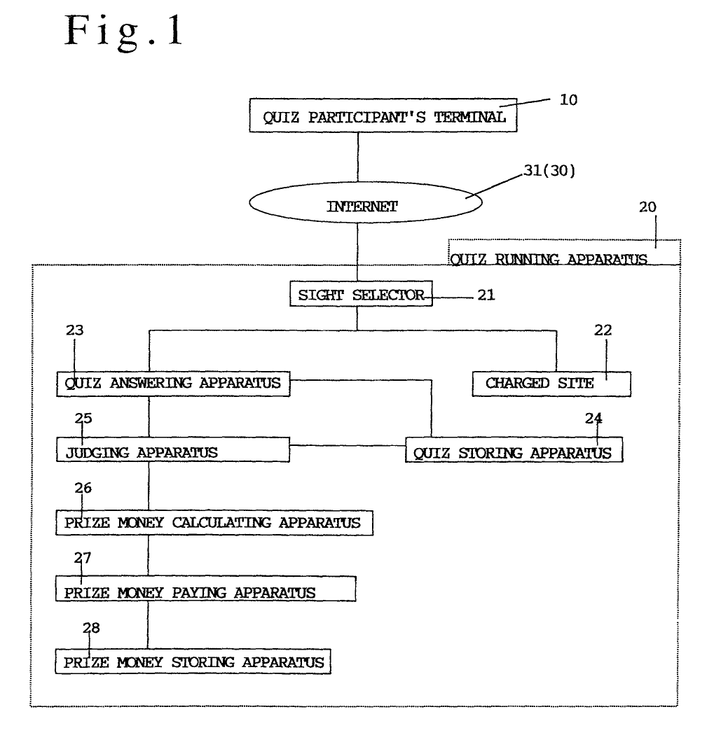

An embodiment of a system for paying quiz prize money according to the invention will now be described with reference to the diagram in FIG. 1 illustrating a system configuration. This system is formed by a terminal 10 of a quiz participant, a quiz running apparatus 20 at a quiz runner and a network 30 connecting them. Each of those apparatuses is constituted by a computer.

The quiz participant's terminal 10 is connected to the quiz running apparatus 20 through the network 30. For example, the internet 31 is used as the network 30.

The quiz running apparatus 20 has a configuration as described below. 21 represents a site selector for causing a quiz participant to select a quiz site or a charged site as a site to be connected. When a charged site 22 is selected, connection is enabled for various sites for on line shopping, music distribution, on line games, auction, charged information and the like included in the same site.

When the quiz site is selected, a quiz answering apparatus 23 transmits quizes selected from among quizes stored in a quiz storing apparatus 24 for storing quizes to be given and right and wrong answers thereto to the quiz participant's terminal 10 as a quizzing screen to cause the quiz participant to input and return answers to the same.

A judging apparatus 25 judges whether the answers to the quizes returned from the quiz participant's terminal 10 are right or wrong, and a prize money calculating apparatus 26 calculates the amount of prize money for right answers to the quizes. The prize money may be calculated simply as an amount in accordance with the number of right answer. Alternatively, the amount of prize money for each question may be different depending on the difficulty of question. Such rules for calculation may be set in the computer in advance. Alternatively, the amount of prize money may be calculated in consideration to the number of quiz participants, the rate of right answers from the participants and the like.

There is further provided a prize money paying apparatus 27 for causing a quiz participant to make a selection on how to pay prize money he or she acquired for right answers to quizes and for settling the prize money in accordance with the selection and a prize money storing apparatus 28 for storing the amount of prize money for each participant in accordance with the method for settling prize money. Referring to how to pay prize money, for example, prize money may be remitted to bank accounts of quiz participants and may alternatively be accumulated in a reservation account managed by the quiz runner to be allotted to payment of expense for quiz participation, expense for charged sites and the like. Such information is managed by storing it in the prize money storing apparatus 28.

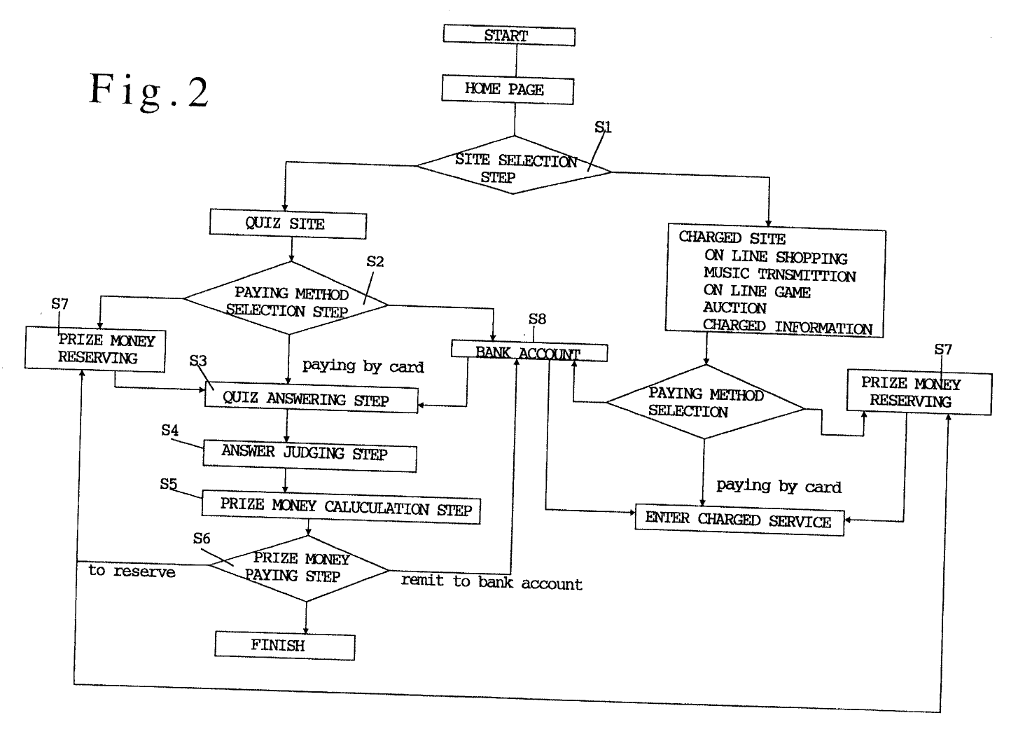

A method for paying quiz prize money using the above-described system will now be described with reference to FIG. 2. First, a quiz participant establishes connection to a home page of a quiz runner's screen provided in a site of the internet and selects a quiz site or a charged site as a site to be connected at a site selection step (S1). When a charged site is connected, a selection is then made from among various sites for on line shopping and charged services and the like.

When the quiz site is selected, a method for paying the participation charge is selected at a quiz participation charge paying method selection step (S2). Any of payment from the quiz prize money reservation account, payment from the bank account, payment using a credit card and the like is selected as the method for paying the quiz participation charge. The bank account and quiz prize money reservation account are also made available to charged sites.

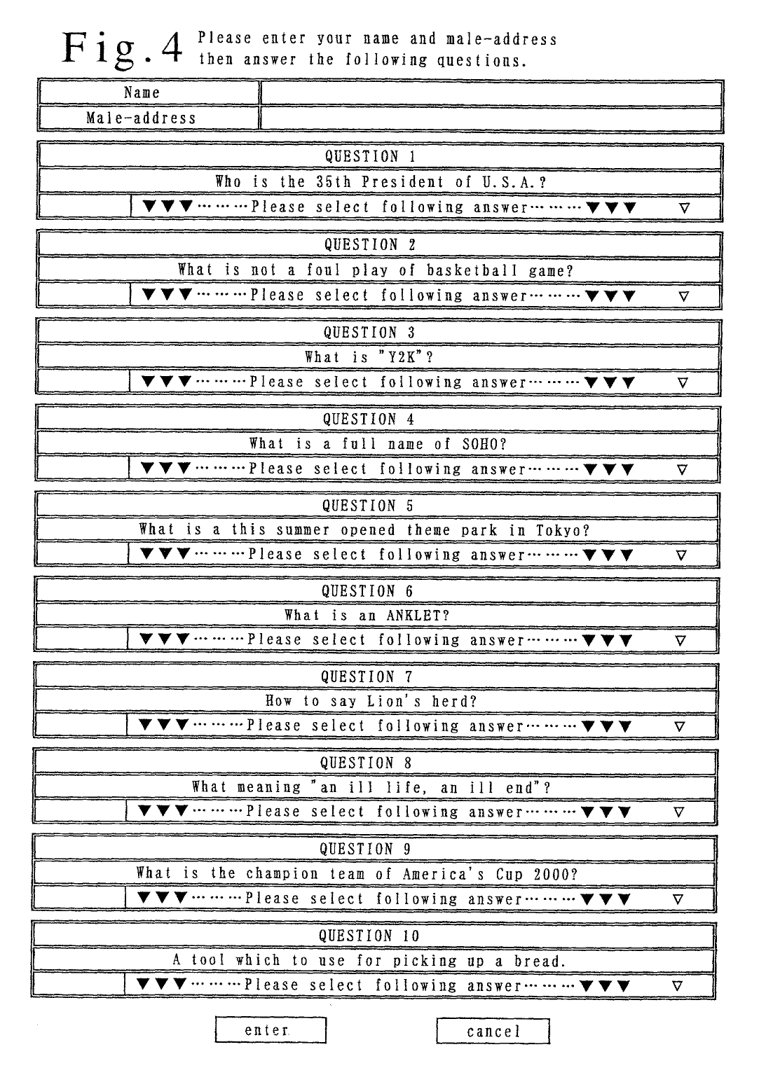

When the quiz participation charge is paid, a quizzing screen as shown in FIG. 4 is transmitted to the terminal of the quiz participant to cause him or her to input answers at a quiz answering step (S3), and it is determined at an answer judging step (S4) whether the answers to the quizes returned from the terminal of the quiz participant are right or wrong. At a prize money calculation step (S5), the amount of prize money for right answers to the quizes is calculated.

Next, a prize money paying step (S6) causes the quiz participant to select a method for the payment of the prize money he or she has acquired for right answers to the quizes. As methods for settling the prize money, the prize money paying step (S6) provides a quiz prize money reserving method (S7) in which the prize money is reserved as the charge for the next participation to quizes or expense for charged sites 12 and a method (S8) in which the prize money is remitted to a bank account designated by the quiz participant. The prize money is settled in accordance with the selection of the quiz participant.

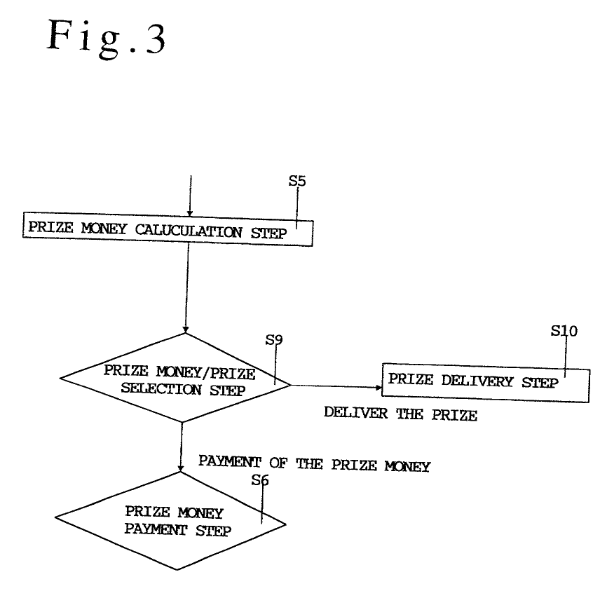

The prize money payment step (S6) for causing the quiz participant to select a method for payment of the prize money and settling the prize money according to the selection may be followed by a prize money/prize selection step (9) as shown in FIG. 3 to allow selection of prize money or a prize, and a prize delivery step (S10) may further follow to take a procedure to deliver a prize when it is selected.

As described above, with the system for paying quiz prize money according to the invention, steps of giving quizes, judging right and wrong answers and calculating the amount of prize money for right answers can be automatically performed by a computer.

Further, prize money acquired by a participant can be settled on line according to the request of the participant.

According to the method for paying quiz prize money of the invention, the use of the internet allows common people to participate in a quiz program easily, and a quiz participant can know the result of a quiz immediately because judgement whether an answer is right or wrong is informed to the quiz participant on line.

A quiz participant can instruct a method for payment of prize money on line after answering a quiz.

Further, prize money can be paid on a cashless basis, which is convenient for both of quiz participants and a quiz runner.

What is claimed is:

1. A system for paying quiz prize money, for connecting a terminal of a quiz participant and a terminal of a quiz runner through the internet and for providing prize money for right answers, comprising:
site selecting means for allowing the quiz participant to select a quiz site or a charged site as a site to be connected;
quiz storing means for storing quizes to be given and right and wrong answers;
quiz answering means for transmitting a quizzing screen to the terminal of the quiz participant to cause him or her to input answers;
judging means for judging right and wrong answers to the quizes returned from the terminal of the quiz participant; and
prize money calculating means for calculating the amount of prize money for right answers to the quizes.

2. A system for paying quiz prize money according to claim 1, comprising:
prize money paying means for causing the quiz participant to select a method for payment of prize money for right answers to quizes and for settling the prize money according to the selection; and
prize money storing means for storing the amount of prize money for each quiz participant.

3. A system for paying quiz prize money according to claim 1 or 2, wherein connection between the terminal of the quiz participant and the terminal of the quiz runner is established using a home page on the internet.

4. A system for paying quiz prize money according to claim 1 or 2, wherein quizes given by selecting them from among the quizes stored in the quiz storing means are given through quiz selection means which gives quizes at random or on a fixed basis.

5. A method for paying quiz prize money in which a quiz participant is connected to a screen of a quiz runner provided in a site of the internet to follow a procedure for participating a quiz program and for answering utilizing the screen and in which prize money acquired for right answers are paid based on a selection instruction from the quiz participant, the method comprising the steps of:
causing the quiz participant to select a quiz site or a charged site as a site to be connected;
causing the quiz participant to select a method for payment of a quiz participation charge;
transmitting a quizzing screen to the terminal of the quiz participant in response to the selection of the quiz participant and causing him or her to input answers;
judging right and wrong answers to quizes returned from the terminal of the quiz participant; and
calculating the amount of prize money for right answers to the quizes.

6. A method for paying quiz prize money according to claim 5, comprising the step of causing the quiz participant to select a method for payment of prize money acquired for right answers to quizes and settling the prize money according to the selection.

7. A method for paying quiz prize money according to claim 6, wherein the step of causing the quiz participant to select a method for payment of prize money acquired for right answers to quizes and settling the prize money according to the selection comprises the steps of:
allowing a prize to be alternatively selected instead of prize money: and
taking a procedure for delivering the prize when the prize is selected.

8. A method for paying quiz prize money according to claim 6, wherein the step of causing the quiz participant to select a method for payment of prize money acquired for right answers to quizes and settling the prize money according to the selection comprises a method in which the prize money is reserved as the participation charge for the next quiz or expense for charged sites and a method in which the prize money is remitted to a bank account designated by the quiz participant.
